(19) United States
(12) Patent Application Publication
(10) Pub. No.: US 2015/0338283 A1
(43) Pub. Date: Nov. 26, 2015

(54) DEVICE AND METHOD FOR TEMPERATURE MONITORING IN MULTIPLE AREAS USING ONE SENSOR

(71) Applicant: HON HAI PRECISION INDUSTRY CO., LTD., New Taipei (TW)

(72) Inventors: YU-CHING CHIEN, New Taipei (TW); CHUANG-WEI TSENG, New Taipei (TW); CHE-HSUN CHEN, New Taipei (TW)

(73) Assignee: HON HAI PRECISION INDUSTRY CO., LTD., New Taipei (TW)

(21) Appl. No.: 14/282,025

(22) Filed: May 20, 2014

(51) Int. Cl. G01K 7/02; G01K 13/00; H02J 7/02

(52) U.S. Cl. CPC G01K 7/02; H02J 7/025; G01K 13/00

(57) ABSTRACT

To monitor temperatures at multiple areas of class D/E power amplifier, DC/DC converting unit and an antenna in a wireless charger, place a thermal conductive and electro-insulative layer covering the class D/E power amplifier, the DC/DC converting unit and the antenna, and use one temperature sensor to sense the temperature of the thermal conductive and electro-insulative layer.

### FIELD

The present disclosure generally relates to temperature monitoring technology and, particularly, to a device and a method for temperature monitoring in multiple areas using one sensor in a wireless charger system.

### BACKGROUND

Wireless chargers nowadays are trendy consumer products. During operation, various parts in a wireless charger can produce a considerable amount of heat due to energy losses, such as coupling loss, switching loss, thus monitoring and adjusting temperatures for those parts or the wireless charger becomes necessary. Traditionally, monitoring temperatures for multiple areas requires a corresponding number of temperature sensors, which would increase cost.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram showing a wireless charger in accordance with an embodiment.

FIG. 2 is a flowchart showing a process of monitoring temperature in multiple areas using one sensor for the wireless charger of FIG. 1, in accordance with an embodiment.

### DETAILED DESCRIPTION

The embodiments are described in the following paragraphs in detail with reference to the accompanying drawings. The disclosure is illustrated by way of example and not by way of limitation in the figures of the accompanying drawings in which like reference numerals indicate the same or similar elements.

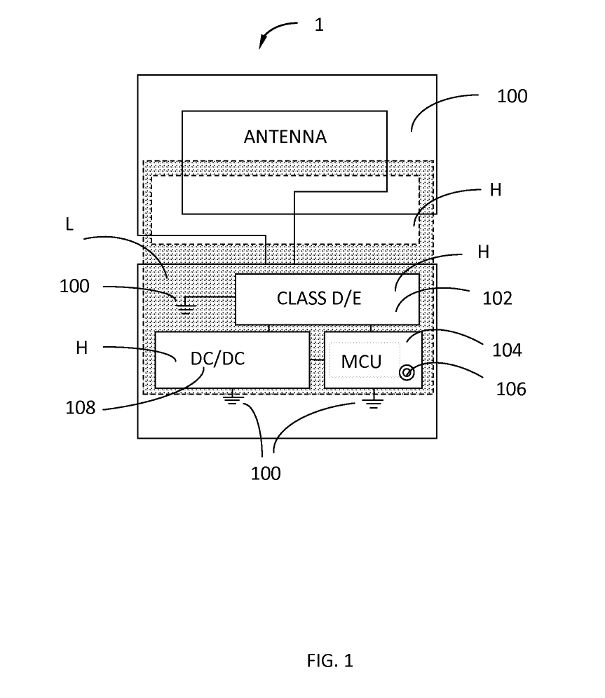

Referring to FIG. 1, an exemplary wireless charger 1 includes, but is not limited to, an antenna (coupling coils) 100, a class D/E power amplifier 102, a DC/DC (direct current) converting unit 108, a microcontroller unit (MCU) 104, and a temperature sensor 106. The class D/E power amplifier 102 and the DC/DC converting unit are coupled to the MCU 104 and feed the MCU 104 for various control purposes.

For a wireless charger, such as the one shown in FIG. 1, it is known in the art that switching loss and coupling loss associated in operation happens and those losses in energy are transformed into heat, which gives rise to the risk of overheating for the wireless charger 1. In one embodiment, as shown in FIG. 1, areas H in the antenna 100, the class D/E power amplifier 102, and the DC/DC converting unit 108 may generate heat in operation and need to be monitored in terms of temperature.

On the other hand, high frequency power signals (or high frequency electromagnetic noise) are employed and produced in the class D/E power amplifier 102. The DC/DC converting unit 108 supplies power to the MCU 104 and the class D/E power amplifier 102, and also generates high frequency electromagnetic noise. In addition, the antenna 100 produces radiation noise during coupling processes. Also those noises generated from the elements can interfere with sensing of temperatures for the elements if the sensors are placed close to those elements. This issue makes it necessary to apply filtering circuit to the temperature sensors to get acceptable reading of the temperatures for those elements, which will increase complexity of the temperature sensing.

To tackle the issue and simplify the temperature monitoring, in one embodiment, a thermal conductive layer L (marked with broken line boarders and filled with cross-lines in FIG. 1) is applied to the wireless charger 1, covering all the areas H that needs to have its temperature monitored, and the MCU 104. The thermal conductive layer L is made of thermal conductive and yet electro-insulative materials, such as thermal conductive silicones. Meanwhile, the temperature sensor 106 is placed adjacent to or mounted to the MCU 104. The MCU 104 is a microcontroller, and uses low driving voltage, for example 3.3v, and thus has relatively low electromagnetic noise and less interference with the operation of the temperature sensor 106. In this manner, the heat generated from the antenna 100, the class D/E power amplifier 102 and the DC/DC converting unit 108 can be conducted to the location of the temperature sensor 106 and its temperature sensed. The temperature thus measured can be regarded as the system temperature for the wireless charger 1, although not necessary an accurate reading for any specific heat-generating element, however, for the purpose of regulating the overall temperature of the wireless charger 1 by the MCU 104, the reading by the temperature sensor 106 at the MUC 104 is good enough to be used. In addition, since the layer L is electro-insulative, the electromagnetic noises from the antenna 100, the class D/E power amplifier 102 and the DC/DC converting unit 108, all covered by the thermal conductive layer L, will not be transmitted via the layer L to the temperature sensor 106, therefore reducing or simplify the need to filtering-out the noises from the antenna 100, the class D/E power amplifier 102 and the DC/DC converting unit 108.

Each of the MCU 104, the class D/E power amplifier 102 and the DC/DC converting unit 108 has its own grounding connection 110, or is independently grounded, to reduce interference among the electromagnetic noises from the MCU 104, the class D/E power amplifier 102 and the DC/DC converting unit 108, to further reduce impact on the reading of the temperature sensor 106 and reduce the need to filtering-out the electromagnetic noises for the sensor.

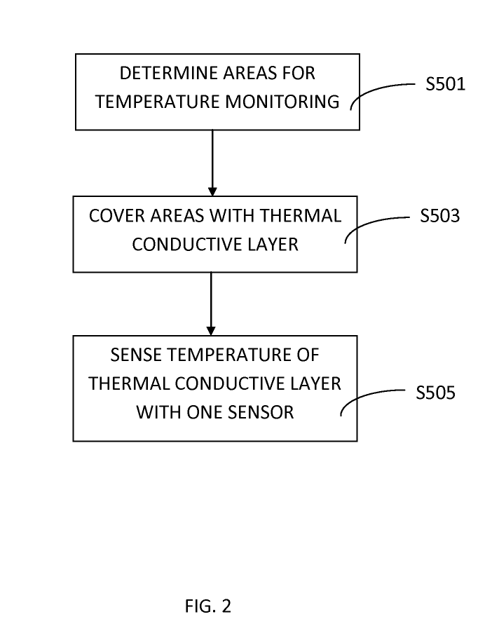

FIG. 2 provides an exemplary process to illustrate principles of monitoring temperatures of multiple areas with one temperature sensor. In task S501, a number of areas (such as the antenna 100, the class D/E power amplifier 102 and the DC/DC converting unit 108 in FIG. 1) whose temperatures need to be monitored are determined. In task S503, a thermal conductive layer L is applied to cover all the areas determined in task S501, and then in task S505, use the temperature sensor 106 to sense the temperature of the thermal conductive layer L. This way, the temperature sensed by the sensor 106 is a reading of compounded effect of the heat generated from all the areas, and this reading can be used as a basis to regulate the temperature by the MCU 104 for the whole system, e.g., the wireless charger 1. Preferably, as described above, the sensor 106 should be placed in a low electromagnetic noises in order reduce the need to filtering-out the electromagnetic noises for the sensor 106.

While certain embodiments have been described and exemplified above, various other embodiments will be apparent from the foregoing disclosure to those skilled in the art. The disclosure is not limited to the particular embodiments described and exemplified but is capable of considerable variation and modification without departure from the scope and spirit of the appended claims.

What is claimed is:

1. A device, comprising:
a first element with a first area of temperature-monitoring;
a second element with a second area of temperature-monitoring;
a thermal conductive layer covering the first and the second areas; and
a temperature sensor sensing temperature from the thermal conductive and electro-insulative layer.

2. The device of claim 1, wherein the first and the second areas are independently grounded.

3. The device of claim 1, wherein the temperature sensor is located in an area of low electromagnetic noise.

4. The device of claim 1, wherein the thermal conductive layer is electro-insulative.

5. A wireless charger, comprises:
an antenna;
a class D/E power amplifier;
a microcontroller;
a DC/DC converting unit powering the class D/E amplifier and the microcontroller;
a temperature sensor positioned adjacent to and coupled to the microcontroller;
a thermal conductive and electro-insulative layer covering the class D/E amplifier, DC/DC converting unit, micro controller and the antenna,
wherein the temperature sensor senses temperature of the thermal conductive and electro-insulative layer.

6. The wireless charger of claim 5, wherein the class D/E power amplifier is independently grounded.

7. The wireless charger of claim 5, wherein the DC/DC converting unit is independently grounded.

8. The wireless charger of claim 5, wherein the microcontroller is independently grounded.

9. A method for monitoring temperature, the method comprising:
determining a plurality of areas of electronic components of a device for temperature monitoring;
placing a thermal conductive and electro-insulative layer covering the plurality of areas; and
sensing a temperature of the thermal conductive and electro-insulative layer using a temperature sensor.

10. The method of claim 9, further comprising:
placing the temperature sensor at a position where low electromagnetic noise is low.

11. The method of claim 9, further comprising:
independently grounding the electronic components.
